(19) United States
(12) Patent Application Publication
(10) Pub. No.: US 2020/0226230 A1
(43) Pub. Date: Jul. 16, 2020

(54) CONTROL UNIT SYSTEM

(71) Applicant: Robert Bosch GmbH, Stuttgart (DE)

(72) Inventors: Gafur Zymeri, Ronnenberg (DE); Klaus Schneider, Ludwigsburg (DE); Andre Barkowski, Baddeckenstedt (DE); Wolfgang Fischer, Hildesheim (DE)

(73) Assignee: Robert Bosch GmbH, Stuttgart (DE)

(21) Appl. No.: 16/330,575

(22) PCT Filed: Aug. 29, 2017
(86) PCT No.: PCT/EP2017/071615

§ 371 Date: Mar. 5, 2019

(30) Foreign Application Priority Data
Sep. 6, 2016 (DE) 102016216821.5

(51) Int. Cl. G06F 21/12; H04L 29/06

(52) U.S. Cl. CPC G06F 21/123; H04L 63/101; H04L 2463/103; G06F 2221/2153; G06F 2221/2141

(57) ABSTRACT

A control unit system includes a control unit on which a rights management system is set up, access permission information being retrievably stored by the rights management system, functions in executable form being stored on further control units of the control unit system, at least one of the further control units being configured as a query control unit set up to execute these functions, or not, based on access permission information stored in the rights management system, characterized in that the control unit also includes a device management system that is configured to establish a connection with a server via a communication interface and to provide the rights management system with an update of the access permissions received from the server via this interface.

### CROSS-REFERENCE TO RELATED APPLICATIONS

The present application is the national stage of International Pat. App. No. PCT/EP2017/071615 filed Aug. 29, 2017, and claims priority under 35 U.S.C. § 119 to DE 10 2016 216 821.5, filed in the Federal Republic of Germany on Sep. 6, 2016, the content of each of which are incorporated herein by reference in their entireties.

### FIELD OF THE INVENTION

The present invention relates to a control unit system.

### BACKGROUND

A method for computer-assisted rights management for systems including at least two different data processing units is known from DE 10 2004 048 126 A1, in which a central rights manager is provided. The central rights manager manages rights information that are associated with data intended for the data processing units, and, based on this rights information, releases the data intended for the data processing units.

### SUMMARY

A method according to the present invention has an advantage over the related art that it can be implemented with particularly little complexity, and integrates well into an existing over-the-air vehicle infrastructure (device management system, content management system). A device management system according to the present invention can be made applicable in a particularly simple manner for the rights management system as well as for other uses.

For establishing a desired business model, it is conceivable to provide properties of software or of a function based on corresponding access permissions in executable form, and for this purpose to keep device data and/or user data and access permission information resulting therefrom (also referred to as licenses or entitlements) so that they are retrievable in the system in which the software or the function is to run.

It is desirable for this access permission information to be securely stored so that it cannot be manipulated but is still updatable. It is thus possible for the enabled functional scope to be changed during the service life of the target device.

It is possible for a rights management system (also referred to as a license management system) to be based on an interaction between the software or function whose execution is based on the access permissions, and a backend system, such as a server, on which access permission information is kept.

The interfaces to the rights management system can be statically incorporated into the software or function. The software or function should then be able to establish a connection to the rights management system at runtime.

In particular, in a vehicle that includes a connectivity feature, an aim is for new functions to be dynamically introduced. For this purpose, the vehicle establishes an appropriate server connection. At the same time, for mobile connectivity, it is not ensured that a continuous connection to the server is present.

In a first aspect, the present invention relates to a control unit system, in particular of a vehicle, including a control unit on which a rights management system is set up, access permission information being retrievably stored by the rights management system, in particular upon request, functions in executable form being stored on further control units of the control unit system, at least one, preferably all, of the further control units being configured as a query control unit, and as such being set up to execute these functions, or not, based on access permission information stored in the rights management system. The control unit also includes a device management system configured to establish a connection with an in particular vehicle-external server via a communication interface and to provide the rights management system with an update of the access permissions received from the server via this interface.

For this purpose, the query control unit can be configured in particular to receive the access permission information directly from the rights management system; i.e., the rights management system is configured, for example, to transmit the access permission information to the query control unit. A function can be a dedicated computer program, or an additional function of a computer program, or the use of a software function with a certain parameter set. A function can also be a function that is implemented, at least in part, in hardware.

With such a system, it is also possible to make dynamic licensing of functions applicable in a “connected” vehicle.

It is thus possible for the access permissions that are valid for a vehicle to be associated with this specific vehicle (which advantageously takes place on the vehicle-external server) and to be robustly and securely introduced into the vehicle and kept synchronous via the server, for the rights management system in the vehicle to be designed in a centralized, robust, and secure manner, and for defined interfaces between the rights management system and the functions in the vehicle to be specified.

It is then possible to design the access permission information for a function based, for example, on an ascertained number of requests for this function, and, for example, to deny the access permission when this number exceeds a predefinable number.

It is also possible to selectively grant this access permission, for example to allow a rental car customer who has reserved the “navigation” feature to use a navigation system.

The access of the query control unit to the rights management system can take place via an interface that is provided locally (using wrappers, for example), or that is designed as a service-oriented communication. In a vehicle, protocols are preferably used that are already established in the automotive field, for example SOME/IP or SOC.

The access permission information is advantageously stored in such a way that it is associated either with a unique tuple that includes a vehicle identification number and a function identification number, or with a triple made up of the vehicle identification number, user identification number, and function identification number. Examples of such are illustrated exemplarily in FIG. 2.

In an example embodiment, the query control unit is configured to inquire the access permission information prior to receipt of the access permission information by the rights management system. Such access advantageously takes place via an API as illustrated in FIG. 3 by way of example. Rights management system API uses are advantageously synchronously compared, using functions, to the access permission information that is locally present in the rights management system. For this purpose, it can be provided to carry out a local comparison to the access permission information, and to advantageously immediately deliver a synchronous response to the query control unit.

In an example embodiment, the rights management system is configured to update the list of stored access permissions according to the received update. Such updating can take place, for example, based on the user identification number or based on the vehicle identification number and the user identification number, as shown in FIGS. 4 and 5 by way of example.

Such updating advantageously takes place asynchronously. These asynchronous activities of the rights management system are advantageously hidden from the query control units and the API of the rights management system.

In an example embodiment, the device management system is configured to keep a list of devices that can be implemented either in hardware or in software, or in a mixed form made up of hardware and software, the device management system being configured to receive, via the interface, information that is addressed to a device on the list, to identify this device, and to provide this information to this device.

In particular, it can be provided that the rights management system is registered by a (vehicle-internal) registration process in the device management system, and is added to the list of devices.

The device management system is thus capable of associating messages and responses, which are received from the server and addressed to the rights management system, with the rights management system. It is thus possible for the rights management system to respond to information that has been sent to it from the server.

In an example embodiment, the device management system is also configured to receive existing access permission information from the rights management system and transmit it to the server, for example together with the vehicle identification number.

This can make it possible for the server to check the information for up-to-datedness and optionally to initiate an update with newer information. This update can then result in creation, modification, or deletion of access permission information in the rights management system.

In an example embodiment, the rights management system transmits the access permission information to a content management system for storage in a memory, the content management system being configured to receive data, in particular from a plurality of control units, and to store it in the memory. This can be implemented in a particularly efficient manner, since also for other applications, the requirements for a robust memory that is secure from manipulation are imposed, not only by the rights management system, but also by other applications.

In an example embodiment, the content management system is configured to store the data in the memory in encrypted form using a hardware security module, only the hardware security module having access to the memory. This allows the trustworthiness and the integrity of the data to be ensured in a particularly efficient manner, and at the same time allows the data to be modifiable.

In an example embodiment, the access permission information is stored in a memory of a control unit which is not the control unit on which the rights management system is set up.

Example embodiments of the present invention are explained in greater detail below with reference to the appended drawings.

### BRIEF DESCRIPTION OF THE DRAWINGS

FIG. 1 shows a control unit system of a motor vehicle, according to an example embodiment of the present invention.

FIG. 2 shows a possible structuring of the access permission information, according to an example embodiment of the present invention.

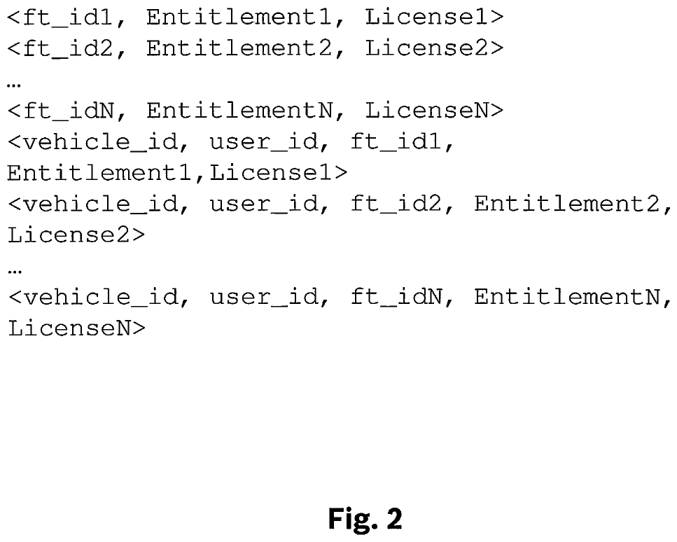

FIG. 3 shows a possible access via the rights management system API, according to an example embodiment of the present invention.

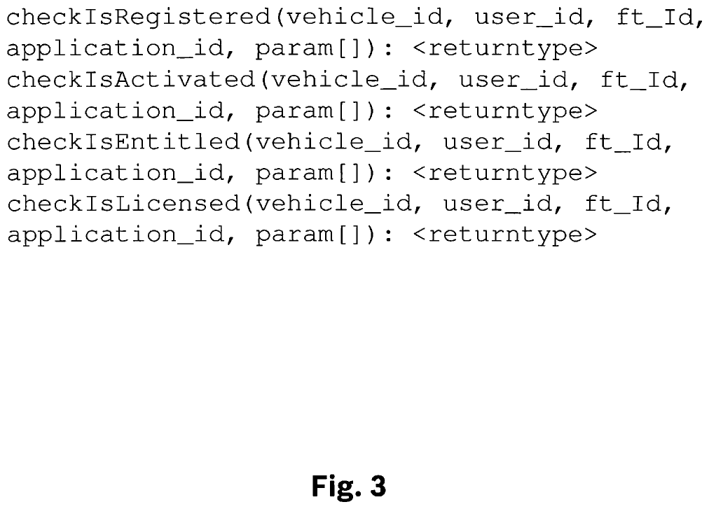

FIG. 4 shows a possible creation, deletion, or modification of the access permission information via the rights management system API, according to an example embodiment of the present invention.

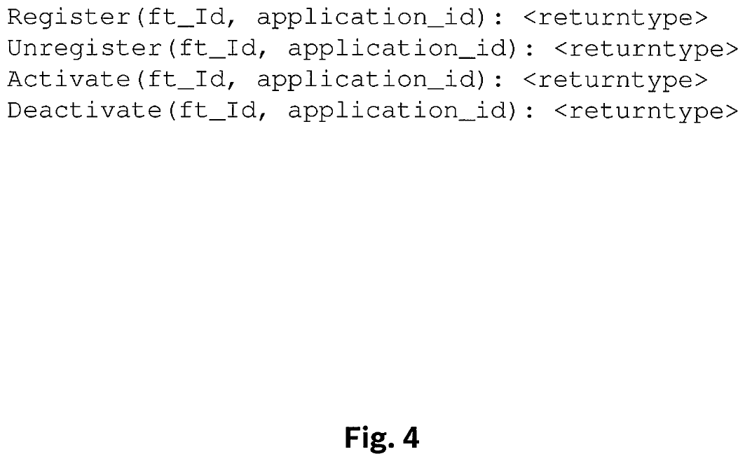

FIG. 5 shows another possible creation, deletion, or modification of the access permission information via the rights management system API, according to an example embodiment of the present invention.

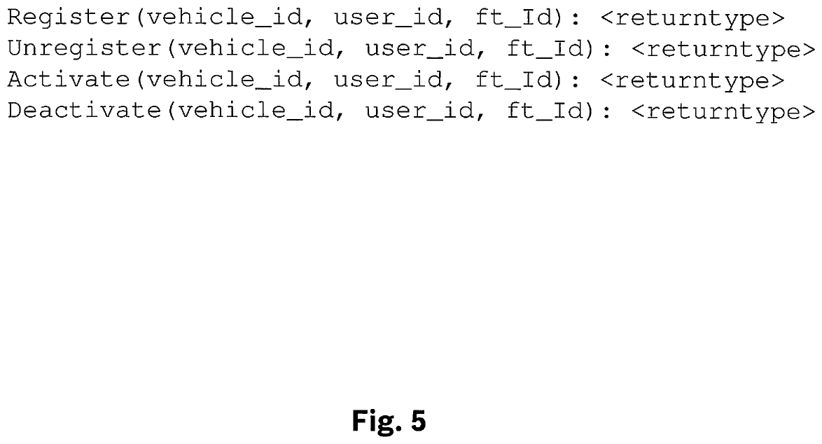

### DETAILED DESCRIPTION

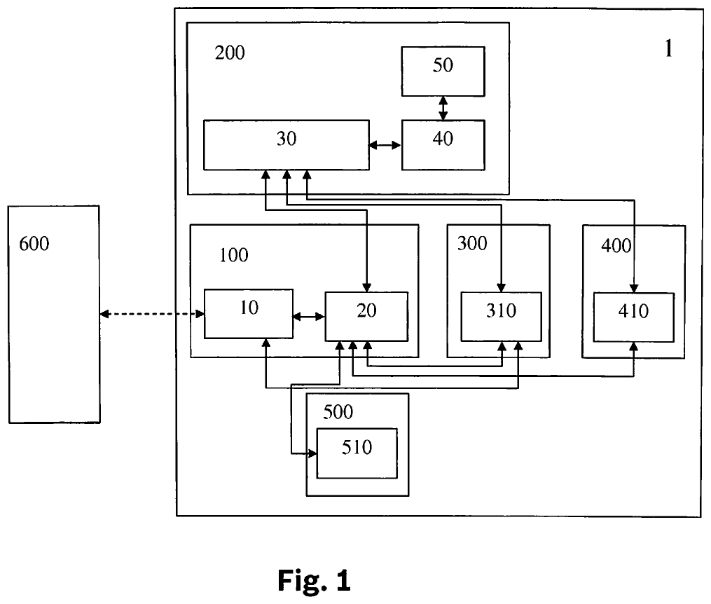

FIG. 1 shows an example of a vehicle 1 that includes a control unit system, with a control unit 100 on which rights management system 20 and device management system 10 are stored. The control unit system also includes further control units 200, 300, 400, 500. Software functions 310, 410 are stored on control units 300, 400. For carrying out software functions 310, 410, the software functions transmit a query to the API of rights management system 20 and inquire whether access permission for carrying out this software function 310, 410 is present at that moment. Control units 300, 400 are logged in with device management system 10 and are addressable by same.

Software functions 310, 410 can be, for example, features that are already present in vehicle 1, but which must first be enabled by appropriate access permission. This can be, for example, a lane-keeping assistant that can be optionally acquired or enabled by the driver of vehicle 1.

Software functions 310, 410 can also be a function that is retroactively installable in vehicle 1. After function 310 is installed, it can be provided that function 310 is logged in with device management system 10.

After the query has been made to the API, the rights management system optionally asks, via an identity management system 510 stored in control unit 500, for the vehicle identification number and the driver identification number, which are transmitted by the control unit to rights management system 20.

Rights management system 20 checks whether the access permission for carrying out software function 310, 410 is present, and reports the result to software function 310, 410. For this purpose, rights management system 20 accesses memory 50 via content management system 30.

Content management system 30 and memory 50 are implemented on control unit 200, which is not control unit 100. Software functions 310, 410 also access memory 50 via content management system 30.

The access of content management system 30 to memory 50 takes place via hardware security module 40, which is likewise installed on control unit 200 and which ensures that the information on memory 50 is not impermissibly retrieved or modified by an attack.

Rights management system 20 is registered with device management system 10. Device management system 10 can establish a connection with vehicle-external server 600 via a connectivity interface. This connection is typically wireless, i.e., “over-the-air.” For example, the backend system for rights management system 600 is installed therein.

Rights management system 20 can provide device management system 10 with instantaneously stored access permission information. Device management system 10 transmits this instantaneously stored access permission information to server 600. Server 600 checks whether this access permission information corresponds to the version of the access permission information that is stored on server 600 at that moment. If this is not the case, server 600 transmits an update of the access permission information to device management system 10. Device management system 10 receives this update, identifies that rights management system 20 is the addressee for the update, and transmits the update to rights management system 20. Rights management system 20 carries out, via content management system 30, a corresponding update of the access permission information stored in memory 50.

It is understood by those skilled in the art that the present invention can be implemented in software, or in hardware, or in a mixed form made up of hardware and software.

1-8. (canceled)

9. A control unit system comprising:
a control unit on which a rights management system is set up and that includes a device management system that is configured to establish a connection with a server via a communication interface, wherein access permission information is retrievably stored by the rights management system and the device management system is configured to provide the rights management system with an update of access permissions received from the server via the interface; and
control units storing executable functions and at least one of which is a query control unit that is configured to execute the functions depending on access permission information stored in the rights management system.

10. The control unit system of claim 9, wherein the query control unit is configured to inquire regarding the access permission information prior to receipt of the access permission information by the rights management system.

11. The control unit system of claim 9, wherein the rights management system is configured to update a list of stored access permissions according to the received update.

12. The control unit system of claim 9, wherein the device management system is configured to:
keep a list of devices;
receive, via the interface, information that is addressed to one of the devices on the list;
identify the device; and
provide the received information to the device.

13. The control unit system of claim 12, wherein the device management system is configured to receive existing access permission information from the rights management system and transmit the received existing access permission information to the server.

14. The control unit system of claim 9, wherein the rights management system is configured to transmit the access permission information to a content management system for storage in a memory, the content management system being configured to receive data and store the received data in the memory.

15. The control unit system of claim 14, wherein the content management system is configured to store the data in the memory in encrypted form using a hardware security module, only the hardware security module having access to the memory.

16. The control unit system of claim 9, wherein the control unit system is configured to store the access permission information in a memory of a control unit on which the rights management system is not set up.
